(19) United States
(12) Patent Application Publication
(10) Pub. No.: US 2009/0247335 A1
(43) Pub. Date: Oct. 1, 2009

(54) HYDRAULIC TENSIONER

(75) Inventors: Kaori Mori, Osaka (JP); Manabu Hirayama, Osaka (JP); Toyonaga Saitoh, Osaka (JP)

Correspondence Address: HOWSON & HOWSON LLP, 501 OFFICE CENTER DRIVE, SUITE 210, FORT WASHINGTON, PA, 19034, US

(73) Assignee: TSUBAKIMOTO CHAIN CO., Osaka (JP)

(21) Appl. No.: 12/391,695

(22) Filed: Feb. 24, 2009

(30) Foreign Application Priority Data
Mar. 28, 2008 (JP) 2008-087275

(51) Int. Cl. F16H 7/08

(52) U.S. Cl. 474/110

(57) ABSTRACT

In a hydraulic tensioner having a hollow plunger that cooperates with a housing to form a high pressure oil chamber, the movable element of the check valve that allows oil to flow into the high pressure oil chamber is a bar-like element that extends into a coiled plunger-biasing spring and is biased into engagement with a valve seat by another coiled valve-biasing spring that extends into the plunger-biasing spring. The bar-like element has a larger diameter portion the diameter of which is slightly less than the inner diameter of the plunger-biasing spring, and a smaller diameter portion the diameter of which is slightly less than the inner diameter of the valve-biasing spring. The valve-biasing spring bears against a shoulder at the location at which the smaller and larger-diameter portions of the bar-like element meet.

### CROSS-REFERENCE TO RELATED APPLICATION

This application claims priority on the basis of Japanese patent application 2008-087275, filed Mar. 28, 2008. The disclosure of Japanese application 2008-087275 is hereby incorporated by reference.

### FIELD OF THE INVENTION

The invention relates to a hydraulic tensioner for maintaining proper tension in an endless, flexible transmission medium such as a timing belt or a timing chain in a vehicle engine.

### BACKGROUND OF THE INVENTION

Hydraulic tensioners have been widely used to maintain proper tension in the timing belt or timing chain of a vehicle engine. A typical hydraulic tensioner comprises a housing having a plunger slidably protruding from a plunger-accommodating hole in the housing. The plunger and the housing together form a high pressure oil chamber that is supplied with oil under pressure from the engine's oil pump through a check valve built into the tensioner. Leakage of oil though a small clearance between the plunger and the wall of the plunger-accommodating hole allows the tensioner to exert a damping action, suppressing vibration of the timing belt or timing chain.

As shown in FIG. 6, which depicts a typical timing drive in a dual overhead cam (DOHC) internal combustion engine, a conventional hydraulic tensioner 500, having a check valve, is attached to an engine body adjacent the slack side of a timing chain C, which is driven by a crankshaft sprocket S1 and operates camshaft sprockets S2. A plunger 520 slidably protrudes from a tensioner housing 510, and applies tension to the slack side of the timing chain C by pressing against the back of a pivoted lever L1 on which the chain C slides. The tension side of the timing chain C slides on a fixed guide L2.

In the tensioner 500, as shown in FIG. 7, the plunger 520 is hollow, and fits slidably in, and protrudes from, a plunger accommodating hole 511 formed in a housing 510. A plunger-biasing coil spring 530 is accommodated within a high pressure oil chamber R formed by the plunger and the housing, and urges the plunger in the protruding direction.

A check valve 540 is press-fit into the housing at the bottom of the plunger-accommodating hole 511 to allow oil to flow into the high pressure oil chamber R while blocking reverse flow of oil.

The check valve 540 comprises seat 541 having an oil passage communicating with an external oil supply (not shown), a check ball 542 which is engageable with an end of the seat 541 facing the interior of the chamber R, a conical coil spring 543, which biases the ball 542 against the ball seat 541, and a retainer 544, which supports the spring 543 and limits the movement of the ball 542.

In the operation of the tensioner, oil in the high pressure oil chamber R leaks through a small clearance between the outer circumferential surface of the plunger 520 and the inner circumferential surface of the plunger-accommodating hole 511, and is discharged to the outside of the housing 510. Impact exerted on the plunger 520 by the timing chain C is damped as a result of the resistance to flow of the viscous oil through the clearance between the plunger and the wall of the plunger-accommodating hole, and vibration of the plunger 520 due to impact is rapidly reduced. Further details concerning the operation of the conventional tensioner can be found in U.S. Pat. No. 7,001,295.

Because oil is supplied to the tensioner by an oil pump driven by rotation of an engine, when the engine is stopped, the supply of oil to the high pressure oil chamber R is also stopped. However, even after the engine is stopped, oil remaining in the high pressure oil chamber R leaks out through the small clearance between the outer circumferential surface of the plunger 520 and the inner circumferential surface of the plunger accommodating hole 511, and is replaced by air. When the engine is re-started after a long interval during which it is not operated, it takes a significant amount of time to replenish oil to the high pressure oil chamber R in order for the damping action of the tensioner to resume. While there is a shortage of oil in the high pressure oil chamber, abnormal vibration noise and backlash of the transmission chain or belt can occur.

The volume of the high pressure oil chamber R can be reduced in order to shorten the time interval between engine-start-up and the resumption of the damping action of the tensioner. However, if the volume of the chamber R is reduced, the plunger biasing spring 530, which is accommodated within chamber R, must either be shortened or its diameter reduced. Consequently, the desirable high load capacity and low spring constant of the plunger-biasing spring are compromised, and the performance of the spring is impaired.

The invention addresses the above-described problems, and provides a hydraulic tensioner in which large elastic force is exhibited during ordinary engine operation, and vibration noise and backlash due to shortage of oil in the high pressure oil chamber on engine start-up are significantly decreased, without the need for a large number of tensioner parts.

### SUMMARY OF THE INVENTION

The hydraulic tensioner in accordance with the invention comprises a housing having a plunger-accommodating hole formed therein, the hole having an opening and a bottom spaced from the opening. A plunger protrudes slidably from the plunger-accommodating hole through the opening. A spring-accommodating hole is formed in the a plunger. This spring-accommodating hole has an opening facing the bottom of the plunger-accommodating hole in the housing, and a bottom located within the plunger at an end of the spring-accommodating hole remote from the plunger opening. The spring-accommodating hole and the plunger-accommodating hole together cooperatively form a high pressure oil chamber.

A coiled plunger-biasing spring, in compression within the high pressure oil chamber, extends into the spring-accommodating hole in the plunger and biases the plunger in the protruding direction.

A check valve allows oil to flow into the high pressure oil chamber and blocks flow of oil out of the high pressure oil chamber. The check valve comprises a valve seat and a bar-shaped valve element. The valve seat is disposed adjacent the bottom of the plunger-accommodating hole and has a seat opening for flow of oil through the valve seat into the high pressure oil chamber. The bar-shaped valve element is engageable with the seat for closing the seat opening. The bar-shaped valve element extends into the coiled plunger-biasing spring and has a shoulder. A coiled valve element-biasing spring is engaged with the bottom of the spring-accommodating hole within the plunger and with the shoulder on the bar-shaped valve element. The valve element-biasing spring is in compression, and biases the valve-element toward the valve seat.

The hydraulic tensioner according to the invention reduces vibration due to impact on the plunger in the same manner in which a conventional tensioner reduces vibration. That is, the viscosity of the oil in the high pressure oil chamber of the tensioner causes the oil to resist flow through the clearance between the plunger and the plunger-accommodating hole, so that a damping effect is realized.

However, the tensioner of the invention exhibits a number of additional effects. In particular, because the bar-shaped element serves as the movable element of the check valve, it is unnecessary for the check valve mechanism to have a ball retainer surrounded by the plunger biasing spring. The use of the bar-shaped element as the movable element of the check valve provides more space for the coiled plunger-biasing spring, and therefore the wire of the plunger-biasing spring can have a larger diameter, and the spring can exert a greater elastic force than that exerted by a plunger-biasing spring in a conventional hydraulic tensioner of the same size.

Furthermore, because the wire of the plunger-biasing spring has a large diameter, and the plunger-biasing spring, the bar-shaped valve element, and the valve-element biasing spring, occupy a large amount of space within the high pressure oil chamber, the volume of the oil chamber is reduced, and the time required for replenishment of oil in the oil chamber on engine start-up is reduced. Thus, the interval between the time the engine is started until the damping action of the tensioner is exhibited is shortened, and vibration noise and a backlash of the timing chain or timing belt are significantly reduced.

Additionally, since the movable element of the check valve is a bar-shaped element extending into the plunger biasing spring, the tensioner of the invention does not require a retainer to support a conical coil spring and check ball as in the case of a conventional check valve. Thus, the number of parts of the tensioner is reduced, and, with an appropriate choice of parts, a overall reduction in the weight of the tensioner can be realized.

In a preferred embodiment of the tensioner, the coiled valve element-biasing spring is wound in a direction opposite to the direction in which the coiled plunger-biasing spring is wound. Thus, even when the outer diameter of the valve element-biasing spring is nearly the same as the inner diameter of the plunger-biasing spring, the two springs can expand and contract without being interwound, and can operate smoothly.

In another preferred embodiment, a recess is formed in the bottom of the spring-accommodating hole within the plunger, and an end of the coiled valve element-biasing spring is received in the recess and prevented by the recess from moving laterally relative to the protruding direction of the plunger. Here again, even when the outer diameter of the valve element-biasing spring is nearly the same as the inner diameter of the plunger-biasing spring, the springs do not interfere with each other, and reliable operation of the check valve can take place.

Preferably, the bar-shaped valve element is composed of a seat portion engageable with the seat to block flow of oil out of the high pressure oil chamber through the seat opening, a larger diameter portion extending in the protruding direction from the seat portion, the larger diameter portion being positioned to limit contraction of the plunger-biasing spring, and a smaller diameter portion extending in the protruding direction from the larger diameter portion, the smaller diameter portion extending into the coiled valve element-biasing spring. Thus, the plunger-biasing spring can expand and contract while its lateral movement is limited by outer circumference of the large diameter portion of the bar-shaped valve element. Therefore, stable and smooth sliding motion of the plunger can be attained.

Furthermore, since lateral movement of the valve element-biasing spring is limited by the small diameter portion of the valve element, interference by the valve element-biasing spring with the plunger-biasing spring can be avoided.

In a preferred embodiment, the seat portion of the bar-shaped valve element is composed of steel. In this case, repeated seating operation of the check valve can take place without deformation of the valve element, even under conditions of high temperature and pressure, and reverse flow of oil can be blocked reliably.

When the plunger is in its fully retracted condition in the plunger-accommodating hole, the bar-shaped valve element, the valve element-biasing spring, and the plunger-biasing spring preferably take up substantially the entire space within the high pressure oil chamber. The amount of oil required to fill the high pressure oil chamber is reduced, and therefore the time required for replenishment of oil in the high pressure oil chamber can be shortened, and noise and backlash can be significantly reduced.

### BRIEF DESCRIPTION OF THE DRAWINGS

FIG. 1 is a schematic front elevational view of an engine timing drive using a hydraulic tensioner in accordance with the invention;

FIG. 2 is a longitudinal cross-sectional view of the hydraulic tensioner shown in FIG. 1, the tensioner having a bar-shaped valve element;

FIG. 3 is a perspective view of the bar-shaped valve element in the tensioner of FIG. 2;

FIG. 4 is a longitudinal cross-sectional view of the hydraulic tensioner of FIG. 2, showing the plunger in a protruding condition;

FIG. 5 is longitudinal cross-sectional view of a hydraulic tensioner according to an alternative embodiment of the invention;

FIG. 6 is a schematic front elevational view of a conventional engine timing drive; and

FIG. 7 is a longitudinal cross-sectional view of a conventional hydraulic tensioner.

### DETAILED DESCRIPTION OF THE PREFERRED EMBODIMENTS

The features of the invention can be incorporated into various embodiments of a hydraulic tensioner, including a tensioner having a ratchet mechanism for limiting retracting movement of the plunger.

The bar-shaped valve element can be made light in weight, even in the case in which its seating portion is composed of steel.

Preferably, the bar-shaped valve element is composed of a seat portion, a large diameter portion integrally formed with the seat portion to limit the plunger biasing spring, and a small diameter portion integrally formed with the large diameter portion to support the valve element-biasing spring. The large diameter portion and small diameter portion provide support for the springs, preventing the springs from becoming deformed, and ensuring smooth and reliable operation.

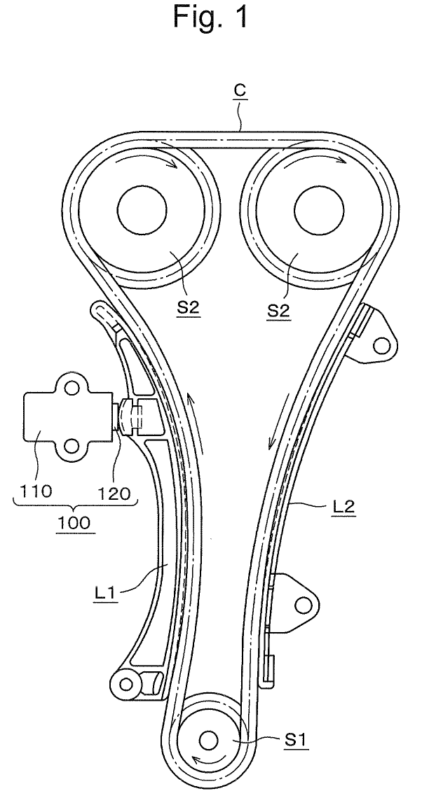

As shown in FIG. 1, in a typical engine valve timing transmission incorporating a hydraulic tensioner according to the invention, the tensioner 100, is attached to an engine block at a location adjacent the slack side of a timing chain C, which is driven by a crankshaft sprocket S1 and in driving relationship with a pair of camshaft sprockets S2. A plunger 120 slidably protrudes from a tensioner housing 110, and applies tension to the a slack side of the timing chain C by pressing against the back of a pivoted lever L1 on which the chain C slides. The tension side of the timing chain C slides on a fixed guide L2. Arrows in FIG. 1 show the directions of chain travel and sprocket rotation.

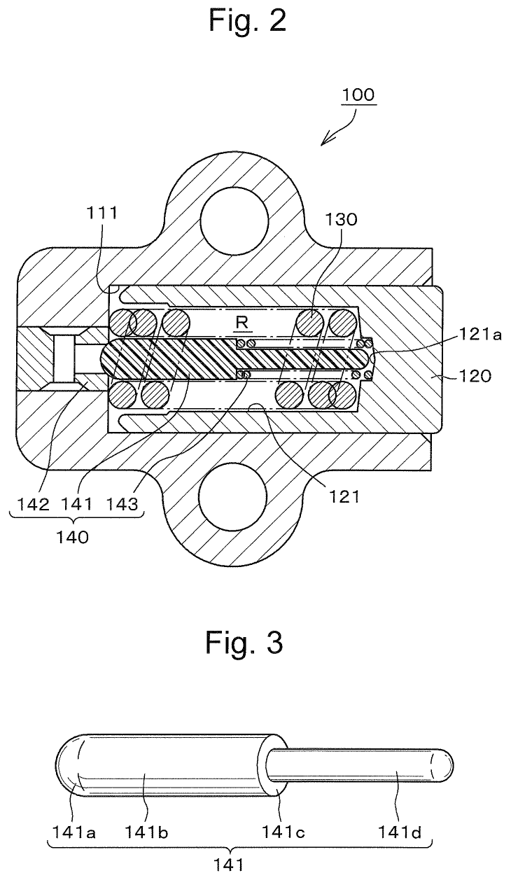

In the tensioner 100, as shown in FIG. 2, the cylindrical plunger 120 is fits slidably into a plunger-accommodating hole 111 in housing 110. The housing has flanges allowing it to be bolted to an engine block. A high pressure oil chamber R is formed between the plunger-accommodating hole 111 of the housing 110 and a spring-accommodating hole in the plunger 120. The spring accommodating hole in the plunger has an opening facing the bottom of the plunger-accommodating hole of the housing, and a bottom inside the plunger at a location spaced from the plunger opening, and, in this case, near the protruding end of the plunger. The spring-accommodating hole receives a coiled, plunger-biasing spring 130, which is in compression, with one end pressing against the bottom of the plunger-accommodating hole and its opposite end pressing against the bottom of the spring-accommodating hole. The spring 130 urges the plunger in the protruding direction.

A check valve mechanism 140 allows oil to flow into the high pressure oil chamber R, but blocks reverse flow.

When a force acts on the plunger, urging the plunger in the retracting direction, oil in the high pressure oil chamber R leaks through a small clearance between the outer circumferential surface of the plunger 120 and the inner circumferential surface of the plunger-accommodating hole 111, and is discharged to the outside of the housing 110. The viscosity of the oil causes a resistance to flow through this clearance. Therefore, if an impact acts on the plunger 120, vibration of the plunger 120 is damped.

As shown in FIG. 2, the check valve mechanism 140 is composed of an elongated, bar-shaped, valve element 141 extending, in the direction plunger protrusion, into the plunger- biasing spring 130. The valve element 141 cooperates with a seat 142 at a bottom of the plunger-accommodating hole 111, through which oil is supplied to the high pressure oil chamber R. Flow of oil is controlled in accordance with movement of the bar-shaped valve element 141 toward and away from the seat 142. A biasing spring 143, which is in the form of small diameter coil spring extending from the bottom of the spring-accommodating hole 121 in the plunger 120 to a shoulder 141c (FIG. 3) of the bar-shaped valve element 141. Spring 143 extends into the plunger-biasing spring 130, and biases the bar-shaped valve element 141 toward the seat 142. The spring 143 is received in a recess 121a in the bottom of the spring-accommodating hole in the plunger, and prevented by this recess from moving laterally relative to the direction of protrusion of the plunger.

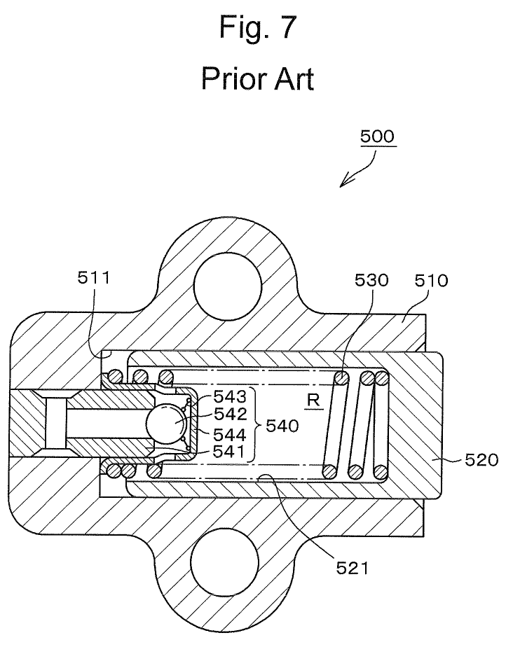

Because the bar-shaped element 141 serves as the movable element of the check valve, it is unnecessary for the check valve mechanism to have a ball retainer surrounded by the plunger biasing spring as in the conventional tensioner of FIG. 7, where the retainer imposes a limit on the inner diameter of the plunger-biasing spring. The use of the bar-shaped element 141 as the movable element of the check valve allows more space for the coiled plunger-biasing spring 130, and therefore the wire of the plunger-biasing spring 130 can have a larger diameter, and the spring can exert a greater elastic force than that exerted by a plunger-biasing spring in the conventional hydraulic tensioner.

Since the wire of the plunger-biasing spring has a larger diameter than that of the wire in the plunger-biasing spring of the conventional hydraulic tensioner, and the bar-shaped valve element 141 and its biasing spring 143 are located within in the high pressure oil chamber, the volume available for oil in the high oil chamber R is greatly reduced. Thus, the time required to replenish oil to the chamber R on engine start-up is shortened, and the delay between engine start-up and the time at which the damping action of the tensioner is exhibited is shortened correspondingly. As a result, abnormal vibration noise and backlash of the timing chain C due to a shortage of oil in the high oil chamber R, are significantly reduced.

Additionally, since the hydraulic tensioner 100 does not require a retainer to support a check ball and a conical check ball-biasing spring, the number of parts is reduced, and a weight reduction can be realized.

The coiled valve element-biasing spring 143 can be wound in a direction opposite to the direction in which the plunger-biasing spring 130 is wound. When these two springs are oppositely wound spring 143 can fit closely within spring 130 without having the springs interfere with each other by becoming interwound. Thus, both springs can operate smoothly, and the check valve can operate reliably.

The valve element-biasing spring 143 engages a shoulder 121 formed on the valve element 141 at a location at which its smaller diameter portion 141d meets its larger diameter portion 141b. Because part 141d of the bar-shaped valve element has a reduced diameter, preferably less than the diameter of the larger diameter part 141b by about twice the diameter of the wire of spring 143, a suitable clearance is provided for spring 143, and the inside of the coiled plunger-biasing spring 130 does not interfere with expansion and contraction of the spring 143 during operation of the tensioner. Therefore, the bar-shaped valve element 141 is reliably biased toward the seat 142.

As shown in FIG. 3, the elongated, bar-shaped, valve element 141 has a seat portion 141a. This seat portion 141a cooperates with the valve seat 142 to blocks a flow of oil out of the high pressure oil chamber. The large diameter portion 141b is integrally formed with the seat portion 141a, and fits within the coiled plunger-biasing spring, elastically limiting movement of the spring in directions transverse to the direction of protrusion of the plunger. The smaller diameter portion 141d of the valve element 141 is integrally formed with the larger diameter portion 141b and extends into the valve element-biasing spring 143. Thus, the plunger-biasing spring 130 can expand and contract while being limited by the outer circumference of the large diameter portion 141b, and the spring 143 can expand and contract while being limited by the smaller-diameter portion 141d, so that they maintain their respective forms, and a stable and smooth sliding motion of the plunger 120 can be realized.

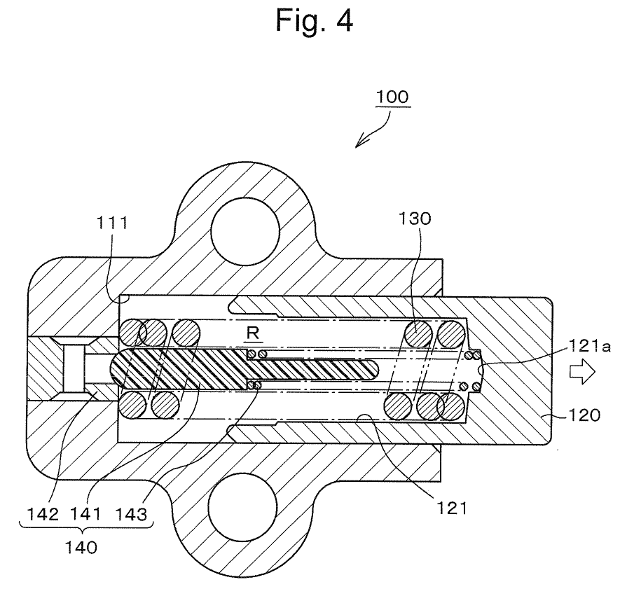

As shown in FIG. 2, where the plunger is in its fully retracted condition, the outer diameter of the coiled plunger-biasing spring 130 is nearly as great as the inner diameter of the spring-accommodating hole in the plunger. The inner diameter of the plunger-biasing spring 130 is only slightly greater than the outer diameter of the larger-diameter part 141b (FIG. 3) of the valve element 141. The outer diameter of the coiled valve-biasing spring 143, being approximately equal to the diameter of part 141b of the valve element, is only slightly smaller than the inner diameter of the spring 130. The inner diameter of spring 143 is only slightly greater than the outer diameter of part 141d of the valve element. When the plunger is fully retracted, each of the springs is nearly fully compressed, with its adjacent turns almost contacting one another. Likewise, the valve element 141 extends substantially the full distance from the seat 142 to the bottom, i.e., the closed end, of the spring-accommodating hole in the plunger. Thus, when the above-described diameter relationships obtain, and the plunger is fully retracted, the two springs 130 and 143, together with the bar-like valve element 141 substantially take up a maximum amount of space within the high pressure oil chamber, leaving a relatively small volume for oil. Even when the plunger is in a protruding condition as shown in FIG. 4, the volume available for oil is larger, but still relatively small. Therefore, whether the plunger is in a retracted or extended condition on engine start-up, the volume of oil needed to replenish the oil content of the high pressure oil chamber is small, and oil replenishment can take place quickly.

In summary, in the embodiment shown in FIGS. 1-4, the space available within the high pressure oil chamber for the plunger-biasing spring 130 is large when compared to the space available for the plunger-biasing spring in a conventional hydraulic tensioner. As a result, the plunger-biasing spring can have the same outer coil diameter, but can be made of a wire having a larger diameter, so that it can exhibit a larger elastic force. The larger diameter of the wire of the plunger-biasing spring also takes up more space within the oil chamber R, and consequently replenishment of oil in the chamber on engine start-up takes place in a shorter time, the damping action of the tensioner is resumed more quickly, and vibration noise and backlash are significantly reduced. Additionally, since the tensioner does not require the retainer, the total the number of parts can be reduced.

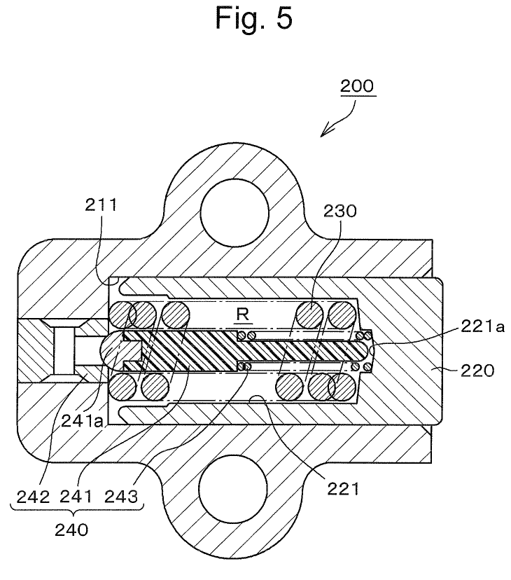

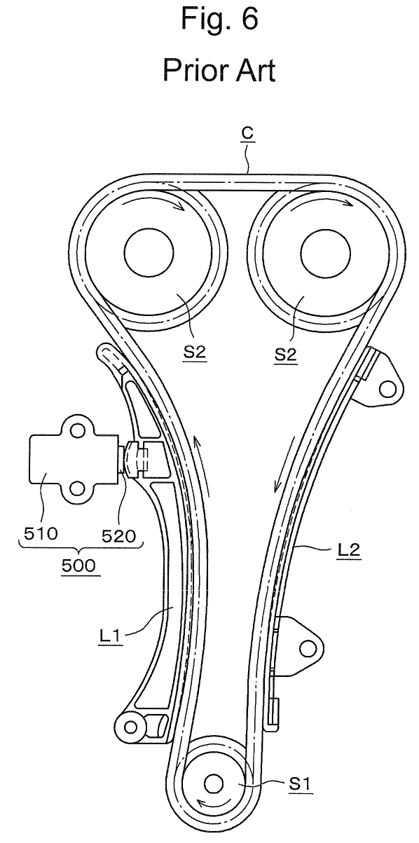

in another embodiment of the invention shown in FIG. 5, a hydraulic tensioner 200 is identical to the tensioner of FIGS. 2-4, except that its bar-like valve element 241 has a seat-engaging portion 241a composed of steel, preferably a stainless steel. The remaining parts are designated by reference numbers which exceed by one hundred the reference numbers that designate corresponding parts in FIG. 2. The steel seat-engaging portion 241 a is resistant to deformation, even in a high temperature, pressure environment, and exhibits superior endurance. The bar-like check valve element of FIG. 5 can engage and disengage the seat 242 repeatedly without becoming deformed, and can therefore more reliably prevent reverse flow of oil from the high pressure oil chamber R.

What is claimed is:

1. A hydraulic tensioner comprising:
a housing having a plunger-accommodating hole formed therein, said hole having an opening and a bottom spaced from the opening;
a plunger slidably protruding from the plunger-accommodating hole, through said opening, in a protruding direction, said plunger having a spring-accommodating hole formed therein with a plunger opening facing the bottom of the plunger-accommodating hole and a bottom located within the plunger at an end of the spring-accommodating hole remote from the plunger opening, the spring-accommodating hole and the plunger-accommodating hole together cooperatively forming a high oil chamber;
a coiled plunger-biasing spring in compression within the high oil chamber, the spring extending into the spring-accommodating hole in the plunger and biasing the plunger in a protruding direction; and
a check valve for allowing oil to flow into the high oil chamber and blocking flow of oil out of the high oil chamber;
wherein the check valve comprises a valve seat disposed adjacent the bottom of the plunger-accommodating hole and having a seat opening for flow of oil through the valve seat into the high oil chamber, a bar-shaped valve element engageable with said seat for closing said seat opening, the bar-shaped valve element extending into the coiled plunger-biasing spring and having a shoulder, and a coiled valve element-biasing spring engaged with said bottom of the spring-accommodating hole within the plunger and with said shoulder on the bar-shaped valve element, the valve element-biasing spring being in compression and biasing the valve-element toward said valve seat.

2. A hydraulic tensioner according to claim 1, in which said coiled valve element-biasing spring is wound in a direction opposite to the direction in which the coiled plunger-biasing spring is wound.

3. A hydraulic tensioner according to claim 1, having a recess formed in said bottom located within the plunger, and in which an end of the coiled valve element-biasing spring is received in said recess and prevented by said recess from moving laterally relative to said protruding direction.

4. A hydraulic tensioner according to claim 2, having a recess formed in said bottom located within the plunger, and in which an end of the coiled valve element-biasing spring is received in said recess and prevented by said recess from moving laterally relative to said protruding direction.

5. A hydraulic tensioner according claim 1, in which said bar-shaped valve element is composed of a seat portion engageable with said seat to block flow of oil out of said high oil chamber through said seat opening, a larger diameter portion extending in said protruding direction from said seat portion, said larger diameter portion being positioned to limit contraction of the plunger-biasing spring, and a smaller diameter portion extending in said protruding direction from said larger diameter portion, the smaller diameter portion extending into the coiled valve element-biasing spring.

6. A hydraulic tensioner according claim 2, in which said bar-shaped valve element is composed of a seat portion engageable with said seat to block flow of oil out of said high oil chamber through said seat opening, a larger diameter portion extending in said protruding direction from said seat portion, said larger diameter portion being positioned to limit contraction of the plunger-biasing spring, and a smaller diameter portion extending in said protruding direction from said larger diameter portion, the smaller diameter portion extending into the coiled valve element-biasing spring.

7. A hydraulic tensioner according claim 3, in which said bar-shaped valve element is composed of a seat portion engageable with said seat to block flow of oil out of said high oil chamber through said seat opening, a larger diameter portion extending in said protruding direction from said seat portion, said larger diameter portion being positioned to limit contraction of the plunger-biasing spring, and a smaller diameter portion extending in said protruding direction from said larger diameter portion, the smaller diameter portion extending into the coiled valve element-biasing spring.

8. A hydraulic tensioner according to claim 5, in which said seat portion of the bar-shaped valve element is composed of steel.

9. A hydraulic tensioner according to claim 1, in which, when said plunger is in fully retracted condition in said plunger-accommodating hole, the bar-shaped valve element, the valve element-biasing spring, and the plunger-biasing spring, take up substantially the entire space within the high oil chamber.

10. A hydraulic tensioner according to claim 2, in which, when said plunger is in fully retracted condition in said plunger-accommodating hole, the bar-shaped valve element, the valve element-biasing spring, and the plunger-biasing spring, take up substantially the entire space within the high oil chamber.

11. A hydraulic tensioner according to claim 3, in which, when said plunger is in fully retracted condition in said plunger-accommodating hole, the bar-shaped valve element, the valve element-biasing spring, and the plunger-biasing spring, take up substantially the entire space within the high oil chamber.

12. A hydraulic tensioner according to claim 4, in which, when said plunger is in fully retracted condition in said plunger-accommodating hole, the bar-shaped valve element, the valve element-biasing spring, and the plunger-biasing spring, take up substantially the entire space within the high oil chamber.
